(19) United States
(12) Patent Application Publication
(10) Pub. No.: US 2010/0224678 A1
(43) Pub. Date: Sep. 9, 2010

(54) Automated contact management

(76) Inventors: Brian Thomas Duk, Mission Viejo, CA (US); Keith Puckett, Denver, CO (US)

Correspondence Address: BLANCHARD & ASSOCIATES, 566 WEST ADAMS STREET, SUITE 600, CHICAGO, IL, 60661, US

(21) Appl. No.: 12/587,404

(22) Filed: Oct. 5, 2009

Related U.S. Application Data
(60) Provisional application No. 61/195,166, filed on Oct. 3, 2008.

(51) Int. Cl. G06F 17/30; G06F 17/00

(52) U.S. Cl. 235/375; 707/610; 707/803; 707/783; 707/E17.005; 707/E17.044

(57) ABSTRACT

A method for contact management using software wherein the user creates an editable personal profile that is assigned a unique identifier code that can be used by a code recipient to access the most recent profile from a databasef.

### REFERENCE TO RELATED APPLICATIONS

This application claims the benefit of priority to U.S. Provisional Application No. 61/195,166, entitled “Automated Contact Management” as filed on Oct. 3, 2008 which is incorporated by reference herein.

### BACKGROUND

Business cards have become the common method of passing along contact information, such as e-mails, phone numbers, fax numbers and other company information. However, the process of making use of the information from business cards is cumbersome and time consuming. Often someone must enter the information into a contact management system, which can result in user error from data entry, or multiple entries for the same individual or business, which creates uncertainty as to which is the most current information. The manual data entry process is time consuming and therefore costly, especially if many business cards are gathered from a convention or other event. Alternatively, some companies now use card scanners that attempt to read the information on business cards and import the information into a contact management system. Although this system would appear to be faster than manual data entry, the time it takes to verify accuracy, due to the error prone process, partly attributable to the multiple possible layouts and fonts of business cards, can create even more work than data entry. Additionally, the data entry method is limited to the amount of information that can reasonably fit on a business card without making the card look cluttered or messy.

What is needed is a method for assigning a unique identification code and corresponding profile to each individual user. The identification code can be short enough to print on any number of places on an existing business card, and can even have an optional corresponding barcode for faster reading. The method employed by the software should be able to facilitate importing information into a contact management system. The system should update the information frequently with any changes that the user makes to his or her profile. Because of the nature of this approach, the profile could be far more detailed that what can be put on a business card and because the profile is managed by each individual user and the software is designed to frequently check the database for changes, far more up to date information can be relayed from one contact to the next with very little effort on the part of either the person with the profile, or the card recipient.

### SUMMARY

The invention is a novel method of contact management, consisting of a software application, a Web interface, and a database. The software application component facilitates contact management through the assignment and use of codes that identify users and permit access to user profiles in a database. The code can be imprinted on business cards, greeting cards, or any other medium to keep track of any desired contact. The software application allows a user to create a personal or business profile by putting his or her contact and personal information into many optional fields and storing that information in a database. The information stored in the database is then correlated with a personal identifier code that is issued to the user who created the profile. The personal identifier code is alpha-numeric, and can be accompanied by a bar code, coding the same information, as well as a unique security code, and the Web address to access the database. When the user gives the code to a third party, regardless of the form, the third party then accesses the database by navigating to the aforementioned Website. The Web interface prompts the third party user to download a software application, and subsequently prompts the third party to enter the requisite personal identifier code (or correlating bar code) and the security code. Both codes can be either entered manually by inputting the numbers and letters on the computer keyboard, or they may be entered using a standard bar code scanner. The bar code scanner embodiment facilitates rapid scanning of multiple cards received at a trade show or convention, or any other venue that could potentially result in the exchange or collection of multiple cards. Once this information is entered, the software automatically synchronizes the information given by the user who created the profile to the third party's contact management system. On specified intervals, the software automatically and continually accesses the database and synchronizes with any updates or changes to the user's profile, which the user may make at any time. The software further allows for an e-mail blast that can import existing Microsoft Outlook (or other contact management system) contacts (all contacts, or those specifically selected), and then broadcast an e-mail using a nexusync template to notify all existing contacts of their subscription to this new contact management system. The template can further contain a Web link to the Website, from which the application can be downloaded and the services sold.

The business card can be coded on its back or front, with visible or invisible ink, and read by certain scanners using compatible wavelengths of light, such as those found in a grocery store or other venue that uses a bar code scanner to identify items. The code can be read by a scanning machine that can be attached, or wirelessly connected, to a computer, and synchronized with Microsoft Outlook or any other contact management system. The person whose information is contained in the card would normally be expected to pay to maintain his/her information on a database that can be located anywhere and can be remotely operated/backed up, etc. The person whose information is contained in the card would further be responsible for updating his/her information in the database, and for selecting one of many options related to the information, such as: 1) automatically request/obtain reciprocal information from the person who has scanned the card and is requesting his/her information, and update that information in the subscriber's Outlook or other contact management system; 2) block all or some users from access; 3) require an access code that the user can write on his or her card before handing it out, or imprint on a newer version of the card, etc. The scanners, the proprietary method for data encoding on the card itself, and the materials to implement the invention can be sold as part of the business model. These items can be licensed to card manufacturing companies. This method will ultimately save lots of money in terms of the time of secretaries and users entering information as they gather business cards, especially from conferences, and has the added benefit of updating everyone's contacts with new information as the user's information changes.

One way to implement the present invention is to initially have a five digit alpha-numeric code above the bar code at the bottom of the back of the business card, and have a symbol with the Web address at the top of the back of the card. At first, people can simply log on to the Website, where they will be prompted to download the application and then enter the code from the card they have received. The code is entered and the information downloads. Once enough people subscribe to the system (and it spreads like a virus), the system can have people register for the service at business card printing shops, where they are issued a code, and given the option to purchase a reader for reading other people's cards. The reader can be sold independently. Since the reader device is so simple, it can be relatively small, and may be able to plug into the USB port of a computer. A wireless version can also be made, as well as a version that can be integrated into a PDA type device. This way, people can simply log on to the Website, insert the code, and be operational. The advertising opportunities are great, as this Website will be highly trafficked. This service can be given away for free initially, in order to get a critical mass of people interested. These initial people would then be expected to tell their friends, and thus the service would grow.

Another way to implement this system is to use a desktop tool that would run the entire system remotely from a database, such that none of the information is actually stored locally on the desktop, which would expedite the download of the software required to run the application that is the substance of the invention.

### BRIEF DESCRIPTION OF THE DRAWINGS

FIG. 1 is a diagram of the method of contact management according to one embodiment of the invention. Arrows indicate the direction of information flow and the process of information flow is described by the labels for each arrow.

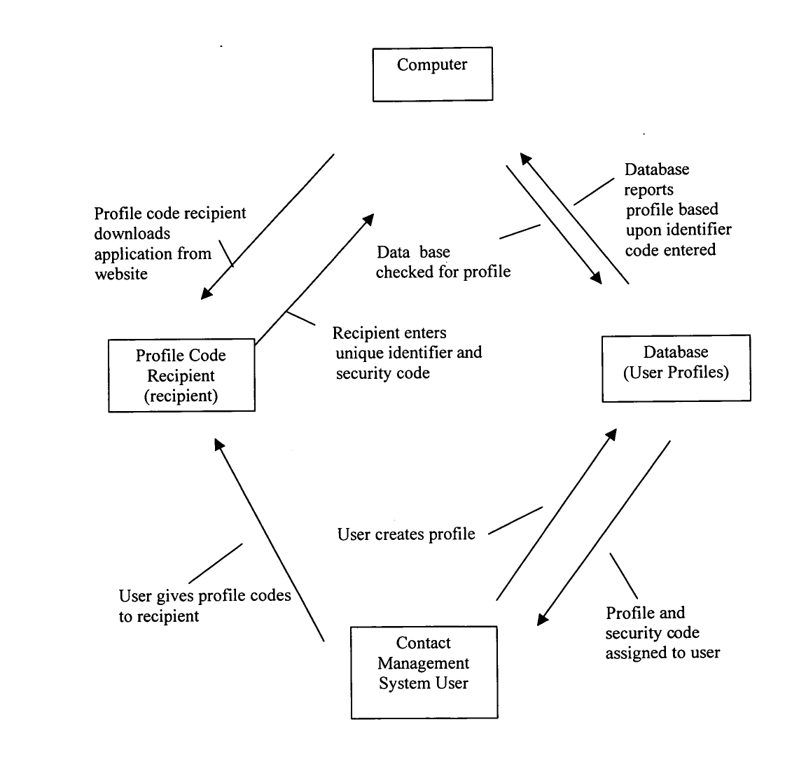

### DETAILED DESCRIPTION

The invention provides a method of contact management that allows a user to create an updateable individual user profile with information identifying the individual, such as one or more fax number, telephone number, e-mail address, secretary contact information, birth date, schedule, or other personally descriptive information.

The software assigns a unique alpha-numeric identifier, security code, and bar code to each individual profile that is created and stores all of the information on a database that is accessible by anyone in possession of the identifier and security code, or barcode and security code. In a preferred embodiment of the invention the alpha-numeric code and the security code are both 3-30 characters long.

In one embodiment, the software is downloadable as either a desktop tool that allows offsite management of software that in turn contacts the database. In another embodiment the software is downloadable as a desktop application that serves to communicate with the database natively. In either embodiment the software provides for periodic communication with a database where user profile information is stored and updated, such that the most current profile is retrieved.

In one embodiment of the invention the profile that is retrieved is synchronized with a contact management system of the recipient of the user's contact profile code's choice.

In one embodiment of the invention the unique identifier code, bar code and security code are exportable individually, in the aggregate, or in any combination of the three, as an image that allows for printing on various types of media. In another embodiment of the invention the unique identifier code, bar code and security code are exportable individually in the aggregate or in any combination, electronically, in other formats that are compatible with devices such as PDAs.

In one embodiment of the invention the barcode is in a form that can be read by a standard USB scanner. In another embodiment of the invention the barcode is in a form that can be read by a PDA device scanner or image-capturing program.

In one embodiment of the invention, the user has the ability to update his or her profile by logging in to the database with a security code to make changes.

In one embodiment of the invention, the software periodically, automatically contacts the database to retrieve the most current profile at an interval specified by the recipient of the unique identifier within the menu provided by the software. In another embodiment of the invention, the updates can be manually performed when the user instructs the software to immediately update the requested profile. Likewise, the profile synchronization with contact management software may be accomplished automatically, or requested manually within the software.

1. A method of contact management comprising:
creating an updateable individual user profile with information identifying the individual,
assigning a unique identifier code to the individual profile,
assigning a unique security code to the individual profile,
assigning a unique bar code to the individual profile, and
using software to:
periodically communicate with a database where user profile information is stored and updated so that the most current profile is retrieved,
export various formats of the unique identifier to be shared with other individuals or entities, and
synchronize the information located in the profile retrieved to the contact management system of choice.

2. The method of claim 1 wherein said identifier code is an alpha-numeric code.

3. The method of claim 1 wherein said profile has fields including standard personal contact information found in commonly used contact management systems.

4. The method of claim 1 wherein the unique identifier code is between 3 and 30 characters long.

5. The method of claim 1 wherein the security code is between 3 and 30 characters long.

6. The method of claim 1 wherein the barcode is optionally included in the format to be exported

7. The method of claim 1 wherein the software exports a printable format of the identifier and security code to be exported as an image.

8. The method of claim 1 wherein the format to be exported is of an electronic form that is compatible with a PDA device.

9. The method of claim 1 wherein the barcode can be read by a standard barcode scanner

10. The method of claim 1 wherein the barcode can be read by a usb scanner for cellular phones or computers.

11. The method of claim 1 wherein the user has the ability to update his or her profile by logging in to the database with a security code to make changes.

12. The method of claim 1 wherein the software periodically automatically contacts the database to retrieve the most current profile.

13. The method of claim 12 wherein the updates can be scheduled at a convenient time interval of the card recipient's choosing.

14. The method of claim 1 wherein the software is a desktop tool that manages profile retrieval remotely rather than on the desktop.
